(19) United States
(12) Patent Application Publication
(10) Pub. No.: US 2008/0320402 A1
(43) Pub. Date: Dec. 25, 2008

(54) Device and Method for Generating a User Interface Configuration for a Field Device

(76) Inventors: Andreas Isenmann, Haslach i.K (DE); Fridolin Faist, Oberwolfach (DE)

Correspondence Address: FAY KAPLUN & MARCIN, LLP, 150 BROADWAY, SUITE 702, NEW YORK, NY, 10038, US

(21) Appl. No.: 12/129,182

(22) Filed: May 29, 2008

Related U.S. Application Data
(60) Provisional application No. 60/945,987, filed on Jun. 25, 2007.

(30) Foreign Application Priority Data
Jun. 25, 2007 (DE) 10 2007 029 136.3

(51) Int. Cl. G06F 3/048

(52) U.S. Cl. 715/762

(57) ABSTRACT

A device for generating a user interface configuration for at least one field device, measuring device, in particular a sensor or actuator, is provided. The device comprises a database and a user interface generating device, wherein the database is designed to store a plurality of device data for the field device, and wherein the user interface generating device is equipped to generate a user interface description file that is allocated to the at least one field device in a predeterminable user interface description language. The user interface description language is selectable from at least two user interface description languages.

### PRIORITY CLAIM

This application claims the benefit of the filing date of U.S. Provisional Patent Application Ser. No. 60/945,987 filed Jun. 25, 2007 and German Patent Application Serial No. 10 2007 029 136 filed Jun. 25, 2007, the disclosures of which are hereby incorporated herein by reference.

### FIELD OF THE INVENTION

The present invention relates to the field of measuring technology. In particular, the present invention relates to an apparatus for generating a user interface configuration for a field device, an apparatus for interpreting a user interface description file, a method for generating a user interface configuration for a field device, a computer-readable storage medium with a program for generating a user interface configuration for a field device, a program element for generating a user interface configuration for a field device, a method for interpreting a user interface description file, a computer-readable storage medium with a program for interpreting a user interface description file, and a program element for interpreting a user interface description file.

### TECHNOLOGICAL BACKGROUND

Measuring devices, in particular a field device that may be implemented as an actuator or a sensor, or an evaluation device, as a rule comprise own user interfaces for operation. These user interfaces often comprise a display device in the form of an LCD display (liquid crystal display) and a plurality of keys or switches. By a user interface that serves as a man-machine interface, or by an input-/output device, the field device allows for a user, operator or handier to operate, configure or parameterise the field device.

During industrial production in a production enterprise in which industrial production at different stations in the production process a sensor has to be interrogated or an actuator has to be adjusted, it may be necessary to use a plurality of evaluation devices or field devices distributed across the production enterprise. However, operating this plurality of measuring devices may turn out to be difficult because operation by the user interface, the user interface provided by the measuring device, can often be effected only locally at the measuring device.

In order to avoid local operation, in large production facilities a central control room is used, from which a measuring device or a field device can be controlled which device is located at a remote location of use. Likewise, a measured value that is generated by the remote measuring device can be displayed in the central control room.

In order to operate a plurality of field devices from a central control room, operating tools have been developed which under a common user interface allow the access to different field devices. The operating tools provide an architecture, a frame work or a frame that, for example, cares for a uniform appearance of displays and operating elements of field devices. By the uniform appearance, operation of the field devices can be simplified.

For the integration of a field device in an operating tool a description of the user interface of the respective field device is necessary. The user interface is prepared individually for each field device. In the user interface, device parameters, i.e. the device description, are described in a description language so that the parameters can be interpreted by the operating tool. Because the description language is standardised for the respective operating tool architecture, it is possible to combine the operation of field devices of different manufacturers under the common operating tool.

The common operating tool can be compared to an overall umbrella management system that allows operating the field devices irrespective of the manufacturer of the field device. The overall management system or operating tool can be used, for example, to display or to illustrate a connection between individual sensors among each other and to allow an overview of the distribution of the field devices within the production enterprise. Examples of operating tools are Emerson AMS, SIMATIC PDM or PACTware™.

For the integration of field devices from different manufacturers in the operating tool, the respective manufacturer of a field device provides a user interface that is adapted to the corresponding field device. Different technologies or technological concepts have established themselves as an architecture for the operating tools, which technologies or technological concepts have to be accommodated during the preparation of user interfaces for the respective operating tool by the description languages. The availability of a user interface for the operating tool available at a user can be of importance for the decision to purchase a field device.

For example the field device tool (FDT) system with device type managers (DTM) exists. The FDT technology provides a number of defined interfaces by which an FDT framework application (e.g. PACTware™) can communicate with the integrated DTMs of the device manufacturers. These interfaces are based on the Microsoft® COM technology (component object model) and allow device manufacturers an uncommitted use of all the Windows operating elements for the design of the user interface of the respective field device. Likewise it is up to the device manufacturer which programming language the device manufacturer uses for the implementation of its user interface. This programming language can, for example, be C, C++ or Visual Basic.

Another concept is pursued by the electronic device description (EDD) concept and by the enhanced EDD (EEDD) concept, respectively. A special description language, the so-called device description language (DDL), exists for the description of the user interface. Only elements that are available in this description language can be used for the design of the user interface.

Irrespective of the technology selected, the device description of the field device after being read into the associated operating tool serves for the illustration or the display of the field device in a user interface within the operating tool or within the operating tool environment. By the interface (surface) generated for the field device in the operating tool, the field device can be addressed by the common operating tool.

However, since these two different technology approaches exist, it is necessary, for the manufacturers of field devices, for each user interface concept to develop an appropriate device description for each individual field device. Each technology comprises different development environments which in turn require individual device descriptions. A device manufacturer is therefore compelled to provide several device descriptions for the same field device.

Furthermore, high maintenance expenditure is necessary, if, in a field device or device, for example expansions of the functions or expansions of the parameters are undertaken, because these changes must also be incorporated in each user interface.

Indeed, conversion tools exist that automatically convert a device description present on the basis of EDD technology into a DTM on the basis of FDT technology. However, each technology provides different possibilities for designing the user interface. In automated conversion, however, only the commonly available functionality can be used. Since the EDD and FDT/DTM technologies use different parameters or functions, only the intersection of the commonly available parameters can be converted from one device description technology into the other device description technology. Thus, for example, it happens that DTMs that have been generated by conversion tools cannot exploit the technical possibilities of FDT technology because the functions or parameters do not exist in EDD technology.

From printed publication DE 102 43 781 an electronic device for a bus system is known.

### SUMMARY OF THE INVENTION

An apparatus for generating a user interface configuration for a field device, an apparatus for interpreting a user interface description file, a method for generating a user interface configuration for a field device, a computer-readable storage medium with a program for generating a user interface configuration for a field device, a program element with a program for generating a user interface configuration for a field device, a method for interpreting a user interface description file, a computer-readable storage medium with a program for interpreting a user interface description file, and a program element for interpreting a user interface description file is provided.

According to an exemplary embodiment of the present invention, an apparatus for generating or configuring at least one user interface configuration for at least one field device is provided. This device for generating at least one user interface configuration or the user interface configurator comprises a database and at least one user interface generating device. The device can also be used for generating a user interface configuration of a plurality of field devices or for several field devices.

The at least one user interface generating device is connected to the database. The database is equipped or adapted to store a plurality of device data for the at least one field device, in particular the device data, parameters or functions of the at least one field device, the at least one sensor or the at least one actuator. The at least one user interface generating device is equipped or adapted to generate a user interface generating file that is allocated to (associated with or corresponds to) the at least one field device in at least one predeterminable user interface description language. The description language is selectable or predeterminable from at least two different user interface description languages, for example FDT or EDD.

The selection of the description language may also be effected by the selection of a user interface generating device. Therefore, the apparatus for generating or configuring a user interface configuration may comprise a plurality of user interface generating devices. The database may be a distributed database.

By at least one selecting device it may be possible to select at least one field device from the database, for which field device the user interface configuration is to be generated, configured or produced. By such a selecting device a selection between several device descriptions present in a database may be taken.

The user interface may be regarded as a graphic representation which representation displays the input parameters or the output values of an associated field device in an operating tool. It may thus be possible to operate a field device from a remote control room.

This may provide a better provision of a device description of a field device.

According to a further exemplary embodiment of the present invention, an apparatus for interpreting a user interface description file is provided. The device comprises an input interface, an interpreting device and an output interface. The input interface is equipped or adapted to receive a user interface description file in a first user interface description language and to forward it to the interpreting device. The interpreting device or interpretation device is equipped or adapted to convert the user interface description file into a second user interface description language and to provide it at the output interface.

In the interpreting device the first description language may be selectable, irrespective of the second description language, from a plurality of, or from at least two, description languages. By converting the first language into the second language it may be possible to flexibly use an available user interface description file in an operating tool.

According to another exemplary embodiment of the present invention, a method for generating or configuring at least one user interface configuration for at least one field device is provided, in which at least one field device is selected for which the user interface configuration is to be generated. At least one user interface description language is predetermined, in which the at least one user interface configuration is to be generated. For the selected at least one field device, in the selected at least one user interface description language, from the existing plurality of associated device data that are stored in a database at least one user interface description file is generated. This at least one user interface description file is adapted to the at least one field device and is also adapted to at least one operating tool. The at least one predeterminable user interface description language is selectable from at least two different user interface description languages. In other words, predetermining the at least one user interface description language may be effected by selecting a user interface description language of at least two user interface description languages.

The at least one user interface description file may represent a user interface configuration. If only one device description for a single field device is stored in the database, selecting the field device prior to generating the user interface configuration may not apply.

According to yet another exemplary embodiment of the present invention, a computer-readable storage medium is created in which a program for generating a user interface configuration for a field device according to the method provided above is stored. When the program is executed on a processor, this program executes selecting at least one field device and predetermining at least one user interface description language. Thereafter, at least one user interface description file, allocated to the at least one field device, is generated in the predetermined user interface description language from a plurality of device data or a plurality of device descriptions that are stored in a database. The at least one predeterminable user interface description language can be selected from at least two different user interface description languages.

A computer-readable storage medium may, for example, be a hard disk, a floppy disk, a CD, a DVD, a read access memory (RAM), a programmable read-only memory (PROM), an erasable PROM (EPROM), a universal serial bus (USB) memory chip or a similar data carrier.

According to yet another exemplary embodiment of the present invention, a program element for generating a user interface configuration for a field device is created, which program element, when executed on a processor, carries out the method provided above.

According to a further exemplary embodiment of the present invention, a method for interpreting a user interface description file is provided, which method receives a first user interface description file in a first user interface description language at an input interface. This file is converted into a second user interface description language by an interpretating device. The file in the second language is provided at an output interface of the interpretating device.

According to a further exemplary embodiment of the present invention, a computer-readable storage medium is provided in which the method for interpreting a user interface description file is stored.

According to yet another exemplary embodiment of the present invention, a program element for interpreting a user interface description file is created.

A device that is to be addressed by a program, an application or software may require a device driver. A device driver may provide a standardised interface that can be accessed by the software. By providing a standardised interface a device manufacturer may be able to develop the device driver irrespective of the software employed and specially-tailored to the device to be controlled.

A field device manufacturer that offers a user interface description file or configuration for an operating tool may in the development of a field device be able to concentrate on the adaptation of the user interface description file without having to offer a separate operating system for the field device.

For integration in an operating tool the device driver, the user interface or the user interface description file may be provided by the manufacturer for the respective field device, sensor or actuator.

The different operating tools may differ in the respective description language used for the configuration file, and also in the parameters provided or functions. During development of the field device, the parameters may be used for documenting the respective field device. However, during operation, the parameters may also be used for inputting information for parameterising, or for outputting information such as measuring results.

Examples of such parameters may be a firmware version, different required help texts in different languages. Examples may also be values that are provided by the field device or that are supplied to the field device.

All these parameters may be stored in a single device description file or in a single database which developers of the field device can access, if need be with different authorisation levels.

In different operating tools, which may be realized as frames or containers, different technologies for the evaluation of the device description or of the user interface description file may be used.

On the one hand, FDT technology may be used which as a user interface description file expects a binary file for the device description, in which the interfaces defined by FDT technology are implemented.

On the other hand, EDD/EDDL technology may be used in which the device description is present on the basis of the predetermined device description language.

The device description based on FDT may provide other parameters or functions than does the EDD device description. Thereby may parameters exist that are used, that are interpreted and that are evaluated by both device descriptions and there may parameters or functions exist that only one of the two device descriptions can evaluate.

With an apparatus for generating a user interface configuration a single device description may be accessed, which device description may, for example, be used for development purposes by developers. Depending on the existing parameters in the single device description, the parameters that may be required by the respective user interface description file or user interface description language may be inserted in a file. Thereby, filter mechanisms may be used which, for example, may be realized in the user interface generating device.

By using of several user interface generating devices the preparation of the user interface description file may be simplified or accelerated.

The user interface generating devices may be connected to a central database such that they can provide the device description in a specifically selected predetermined user interface description language.

It may thus be an idea of the invention to administer a plurality of parameters in a central location, in order to generate from it a user interface description file that is adapted to the respective selected operating tool. Thereby, the expenditure for developing and providing several user interface description files may be saved.

The complete device description of a field device may be deposited in the central database, irrespective of the technology of the operating tools. Thus, changes may need to be carried out only at one location. Depending on the target platform of the user interface to be generated, from the central database either a binary code or a binary file may be generated, or data may be generated that can be interpreted by a runtime environment, for example in the form of an ASCII file.

From the single device description or from the complete device description, the device-internal operation (e.g. for the device operation unit or for the web interface (surface) integrated in the device) may be generated.

The user interfaces that are required for the different operating tools, in particular the description or description file, may be automatically derivable from the data present in the common database. It may thus be possible to fully exploit the different operating tools and in particular the extent of a user interface description language.

In other words, this means that the number of parameters that are deposited in the central database for the description of a field device or a plurality of field devices, may be greater than the number of parameters that may be provided by an individual operating tool, in particular by the description language of the individual operating tool or the user interface description file for the individual operating tool. The parameters that are provided by a user interface description language, in particular by a user interface description file, may be a true subset of the device description deposited in the central database.

By allocating parameters that are present in the central database to corresponding parameters in the respective user interface description file, the user interface configuration may be able to be generated. A user interface generating device may be provided independently of the field device type that may be described in the central database.

Hereby, the user interface generating device may, depending on the technology of the operating tool, generate data that is interpreted by the operating tool itself in order to display the user interface. The user interface generating device may also be equipped or adapted to generate data that is interpreted by an interpreter or by an interpretation device, which interpreter may be provided to the operating tool. The interpreter may interpret the generated data in order to display the user interface. In this way it may be possible to generate configuration data in a proprietary user interface description language and to make this configuration data available to the interpreter. The interpreter may in real time convert the data into a standard user interface language, such as DDL or FDT. This converted data may be displayed by a standard operating tool.

For example, it may be possible to generate user interface description files in XML and to display this data in a user interface that is based on a binary description language. It may also be possible to read the XML data into a user interface that is based on a description language in the ASCII (American standard code for information interchange) format or on some text format other than XML. The language of the file, which file is made available to the interpreter, may differ from the language of the file, which file the interpreter makes available to the operating tool. The interpreter takes up the function of middleware.

In a further embodiment, the user interface generating device may also generate binary data directly, which binary data includes the display of the user interfaces.

In the central database or in the common database a complete device description for at least one field device or for a plurality of field devices may be deposited, irrespective of the technology of the operating tools. Having to provide a user interface configuration file during the process of developing a field device may thus be avoided. Changes that result in the course of development or in the course of the development process of the field device may have to be made only in a single location, for example in the database. Thereby, the user interfaces for the different operating tools may automatically be able to be generated or derived from this common database.

In the central database the device description may be deposited in the form of the existing functions, device parameters, parameter dependencies, limiting values, texts in different languages, input forms, communication rules, etc. for the various devices.

Depending on the user interface description file to be generated in the predeterminable user interface description language, the user interface description language may depend on the target platform. In this context “target platform” refers to the technology on which the respective operating tool may be based. Depending on the target platform of the user interface to be generated, either code or data can be generated from the central database, wherein the data can be interpreted by a runtime environment.

According to yet another exemplary embodiment of the present invention, the predeterminable user interface description file can be interpreted by a frame.

A frame may be the designation of an operating tool architecture. A frame may be based on a standard for a frame. Since there may be various technologies of operating tools, there may also be different frames. A user interface description file that can be interpreted by a special frame may be conforming to or compatible with the frame. The description language on which a user interface description file is based may be conforming to a standard on which the operating tool is based, into which operating tool the user interface description file is to be read-in.

A user interface description file may be able to be supplied to the frame also by the interpreter. In this way the generation of the configuration may be independent of the user interface or independent of the frame.

In order to generate several different user interface description files there may be different user interface generating devices that from the plurality of the parameters present in the central database may make a selection of parameters. This selection of parameters may correspond to the number of parameters for the respective operating tool, in particular for the technology for the operating tool, so that the possibilities of the different operating tools may be fully exploited. I.e., that any parameter (all the parameters) that are provided by the respective description language may be exploited.

According to yet another exemplary embodiment of the present invention, the frame is selected from the group of frames consisting of PACTware™, FieldCare, SmartVision, Melody, Freelance, CX Profi Bus, FDT Container, Fieldmate, Field Device Manager, SIMATIC PDM, Emerson AMS, Emerson Delta V etc.

By providing user interface generating devices which offer a user interface description file that is compatible with the respective frames, the flexibility of the apparatus for generating a user interface configuration may be increased. With a plurality of user interface generating devices, a wide field of available frames or frame standards may thus be able to be covered.

In the case of the development of a new frame technology, the apparatus for generating a user interface configuration for a field device may easily be expandable in that a corresponding new user interface generating device is provided. Such an additional user interface generating device may easily be integrateable in the apparatus for generating a user interface configuration.

According to a further exemplary embodiment of the present invention, the apparatus for generating a user interface configuration for a field device comprises an input device. The input device is connected to the database, and the input device is equipped or adapted to allow inputting the plurality of device data and parameters for the field device. The database may be fed via the input device.

The input device may comprise a communication network so that remote access to the central database may become possible, for example via the internet. Furthermore, the input device may comprise a user rights administration by which it is possible to control which user can access which parameters or functions that are provided in the central database for a corresponding field device.

According to a further exemplary embodiment of the present invention, the input device comprises a user rights administration or an operator rights administration.

By the user rights administration it may be possible to predetermine which group of persons is authorised to place, change or delete which device data in the database. Such groups of persons can, for example, be employees of a development department, of a sales department or of a marketing department. Employees within the departments may also have different authorisations. For example a differentiation may be made according to development teams.

The user rights administration may also be set up within the database by access rules to the database. Thereby, the user administration of the operating device may access the access rules of the database.

According to another exemplary embodiment of the present invention, the at least one user interface generating device comprises a user rights administration.

The user rights administration of the user interface generating device may be independent of the user rights administration of the input device. The user rights administration of the user interface generating device may make it possible for different users to generate different user interface description files. The user rights administration of the user interface generating device, too, may access the access rules of the database.

In the central database a plurality of parameters may be stored which belong to different field devices. In particular if a plurality of device description data for several devices is available, by user rights it may be possible to set that data, information or parameters that belong to a particular field device may only be accessed by the development team that is responsible for the development of the field device.

A user rights administration may make it possible for the entire product range of a field device manufacturer to store any versions and any field device types and in particular their device descriptions in a common database, and, for generating the user interface description files, to select only a sub-group of the available information. The selection may be a view or a section of the data that is available in total.

Furthermore, it may be possible, by a remote query to query a current set of device descriptions for a special predeterminable field device via a network. Thereby, the generation of the user interface description file may be possible online whereby the latest version of a user interface description file for a field device can be accessed. It may, however, be possible for the respective development team to predetermine which of the available parameters can be queried.

According to yet another exemplary embodiment of the present invention, the user interface description file may be selectable from the group consisting of a binary file and a text file or ASCII file.

By providing both binary files and text files the provision of a user interface description file for any operating tools or operating tool technologies may become possible.

According to yet another exemplary embodiment of the present invention, the user interface description language on which the user interface description file is based may be selected from the group consisting of the device description language (DDL), extensible markup language (XML) and field device tool (FDT). In another exemplary embodiment, one or a plurality of proprietary file formats may be used for the description of the user interface. A proprietary file format may be based on a proprietary description language that differs from the standardised description languages DDL, XML or FDT.

By providing these different user interface description languages it may be possible to integrate a field device in a plurality of different operating tools. In the case of development of a new description language, the apparatus for generating a user interface configuration may be adaptable to the new description language in that a corresponding user interface generating device is provided.

According to a further exemplary embodiment of the present invention, the plurality of device data comprises a first number of device-specific parameters, and the user interface description file comprises a second number of device-specific parameters. For example, the first number of device specific parameters may be larger than the second number of device-specific parameters.

By the different number of supported device-specific parameters it may be possible to provide sub-groups of device-specific parameters.

According to yet another exemplary embodiment of the present invention, the device-specific parameters are selected from the group consisting of a field device name, a sensor name, an actuator name, an access right, a version number of the version, a device type, an existing function, a device parameter, a parameter dependence, a limiting value, a text in different languages, an input form, and a communication rule.

Going beyond these device-specific parameters, different field devices may require different parameters, and it may thus be necessary to predetermine in the central database this plurality of parameters that are used for the description of the field device. Using these stored device-specific parameters, a developer may be able to gain a quick overview of the existing parameters for a field device.

According to a further exemplary embodiment of the present invention, the central database is selected from the group of databases consisting of an Oracle database or any arbitrary SQL database, for example the Microsoft® SQL server or MySQL. Any database equipped or adapted to store data may be useable. In particular, the database may also be present in the form of a simple file (text file or binary file). This file may either be of a proprietary structure or, for example, it may be available as an XML document. In that the apparatus for generating a user interface configuration is based on different databases it may be possible to integrate the apparatus in an existing server structure of an enterprise.

According to another exemplary embodiment of the present invention, the apparatus for generating a user interface configuration for at least one field device comprises a web server, wherein the web server is equipped or adapted to control the apparatus for generating a user interface configuration for a field device respectively to regulate the apparatus for generating a user interface configuration for a field device.

It may be possible to access the web server by a web client whereby data maintenance of the device-specific parameters on the central database may be able to be carried out via the internet or via any other internet protocol network (IP network).

According to yet another exemplary embodiment of the present invention, the at least one field device is selected from the group of field devices consisting of a fill-level measuring device, pressure measuring device and a flow measuring device.

It may be possible to provide at least one or a plurality of user interface description files for different field device types.

According to yet another exemplary embodiment of the present invention, the apparatus for generating a user interface configuration for at least one field device comprises a network interface, wherein the network interface is equipped or adapted for the access to the database via a network.

The network interface may be arranged either on the input interface or on the output interface. A network interface may be a modem by which an access via the public telephone network is possible. Furthermore, an interface to a mobile radio network may be available. Therewith an input of new description parameters as well as a query of user interface description files via the respective network may be possible. The network may be any data communication network and voice communication network, respectively. The internet may be a further example of a network.

According to yet another exemplary embodiment of the present invention, the central database is implemented as an expert system. An expert system may allow the link of different data whereby the querying or searching of individual parameters or combinations of parameters is simplified. By the expert system a version check during the development of a field device may also be carried out.

According to a further exemplary embodiment of the present invention, the interpretation device is equipped or adapted to convert a user interface description file that has been generated by a user interface generating device.

According to another exemplary embodiment of the present invention the input interface is equipped or adapted to receive a user interface configuration file that has been generated by the apparatus for generating a user interface configuration.

According to yet another exemplary embodiment of the present invention, the first user interface description language is a text-based description language, for example XML.

According to yet another exemplary embodiment of the present invention, the second description language is a standard user interface description language, as for example EDD or FDT.

Many embodiments of the invention have been described with reference to the apparatus for generating a user interface configuration for at least one field device. These embodiments also relate to the method, the computer-readable storage medium and the program element. Likewise, they apply to the apparatus for interpreting a user interface description file, to the method for interpreting a user interface description file, to the computer-readable storage medium comprising the method for interpreting a user interface description file and to the program element for interpreting a user interface description file.

In the following, further exemplary embodiments of the present invention are described with reference to the figures.

### BRIEF DESCRIPTION OF THE DRAWINGS

FIG. 1 shows an apparatus for generating a user interface configuration according to an exemplary embodiment of the present invention;

FIG. 2 shows a flow chart for a method for generating a user interface configuration for a field device according to an exemplary embodiment of the present invention;

FIG. 3 shows a block diagram of an operating tool with an interpreter according to an exemplary embodiment of the present invention.

### DETAILED DESCRIPTION OF EXEMPLARY EMBODIMENTS

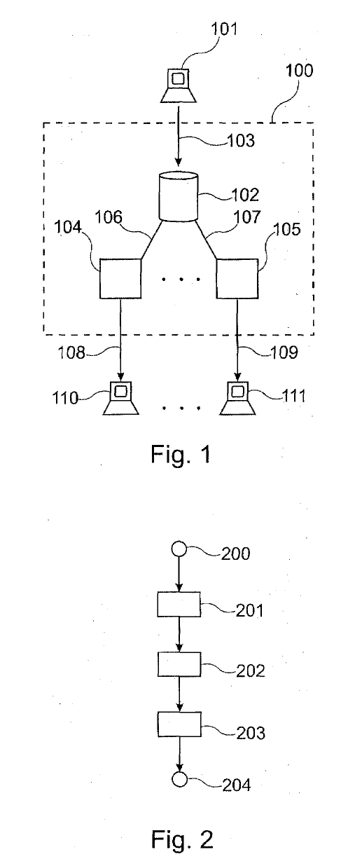

The illustrations in the figures are diagrammatic and not to scale. In the following description of FIG. 1 and FIG. 2 the same reference signs are used for identical or corresponding elements.

FIG. 1 diagrammatically shows an apparatus 100 for generating a user interface configuration for at least one field device or at least one measuring device. By the input device 101, which in FIG. 1 is shown as a PC (personal computer) 101, it is possible to enter in the central database 102 the device descriptions of one or a plurality of field devices, sensors, or actuators. A device description comprises, for example, parameters or functions of the field device.

The connection 103, input interface 103 or interface 103 between the input device 101 and the central database 102 can be implemented as a direct connection 103 or as a network connection 103. By access control mechanisms (not shown in FIG. 1), rights, rules or policies can be set which allow that only a certain selection of persons be able to access certain data in the central database. It is thus possible to control that a development team, in particular members of a development team for fill-level measuring devices, are able to access only the different models, in particular the device descriptions of the different models of fill-level measuring devices.

In the central database 102 the device descriptions are stored, depending on the version, as models in relation to the really existing field devices. Per device, in particular per device type, parameters, functions or texts such as help texts or texts in various descriptions, photos of the field devices or other device descriptions are stored in relation to the real field device.

The apparatus 100 for generating a user interface configuration for at least one field device further comprises the plurality of user interface generating devices 104 and 105. While FIG. 1 shows only two user interface generating devices 104, 105, an apparatus for generating a user interface configuration can comprise a plurality of different user interface generating devices 104, 105. The apparatus may, however, also comprise only precisely one user interface generating device 104, 105. The user interface generating device 104, 105 is connected to the central database 102 by the connection 106, 107 or the connection line 106, 107.

By the connection 106, 107, the user interface generating device can select from the central database 102 the device descriptions that are relevant to the user interface generating device. The data that is relevant to the user interface generating device 104, 105 depends on the target platform for which the user interface description file that has been generated is to be used. Via the output interface 108, 109 the output of a user interface description file is made possible in the respective data format of the target platform. The interfaces 108, 109 can also be implemented as network interfaces 108, 109.

The different file formats are shown in FIG. 1 by the different interfaces 108 and 109. However, it is also imaginable that there is only a single interface 108, 109 by which the different description files are provided. These interfaces can be directly connected to the control PC 110, 111, to the evaluation device 110, 111, or to the operating tool 110, 111. However, the importing of the user interface description file into the operating tool 110, 111 can also be effected by a data carrier or storage-medium, as a USB memory chip, a memory card, a floppy disk, a CD, a DVD or a hard disk.

FIG. 1 shows two different operating tools 110, 111 that are based on different technologies. For example, it can be an FDT-based operating tool 110 and an EDD-based operating tool 111. By a selection device (not shown in FIG. 1), it is possible for a user to select a device description for a certain field device and for a certain target system, or at least to select a certain target system. The selection of the relevant parameters from the common data of the central database can, for example, be effected by filter mechanisms.

The device descriptions for a certain field device can be generated in a batch operation for all available target systems. By a “batch operation” a controlled processing of individual operations may be understood. It is also imaginable that in the batch operation the user interfaces for a target system for all the field devices stored in the database are generated. In a further embodiment, in the batch operation the user interfaces are generated for all the field devices for all the available target systems, which field devices exist in the database.

FIG. 2 shows a method for generating a user interface configuration for a field device, wherein the method starts in step 200 in a starting point. The method starts in step 201 with the selecting of the field device or the field device type for which the user interface description file is to be generated. In this step at least one individual field device, several or all field devices available in the database can be selected.

In step 202 the description languages or the target systems are selected for which the user interface descriptions, configurations or user interface description files are to be generated. Hereby it is possible to select only a single target system, at least one target system, several target systems or all available target systems. In step 203 the user interface description files are created depending on the selected field devices and target systems.

The method closes at end point 204.

The parameters or the device description in the central database is comparable to a device catalogue or a device library. Different operating tool manufacturers use different frames and different technologies for the description of the user interface. Parameters or device descriptions can be stored in a central database in a first format and can be converted to a second format that corresponds to a desired user interface description language.

A user interface description file that is created can be referred to as a target file.

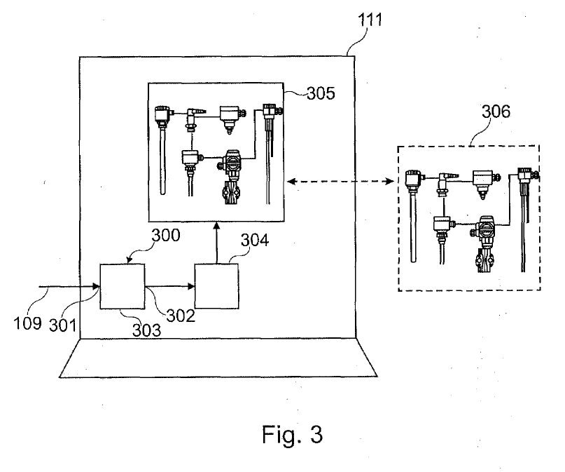

FIG. 3 shows a block diagram of an operating tool 110, 111 with an interpreter 300 according to an embodiment of the present invention. Via the input interface 301, the operating tool 110, 111 receives a user interface configuration in a first language. This user interface configuration, in particular the user interface configuration file, can be imported into the operating tool 111 via the network connection 109. A further possibility of importing the configuration is not shown in FIG. 3. This further possibility relates to importing the file by way of a reading device. The reading device can read-in a data medium (data carrier) on which the file is stored.

In the interpretation device 303 the user interface configuration file is converted from the first language to the second language. The first user interface description language may, for example, be an XML file that is constructed according to a proprietary scheme that is unknown to the operating tool engine 304. The second user interface description language may, for example, be EDD, which is known to the operating tool engine 304. Thus, a description language can be employed whose format is unknown to an operating tool engine 304, and can be converted into a format that is known to the operating tool engine 304. The configuration is provided at the output interface 302 in a known user interface description language or in a known format. In the interpretation device 303 it can be selected from at least two target description languages for the file that is provided at the output interface 302.

The operating tool engine 304 receives the configuration in the known language, for example in EDD or FDT, and from this can generate the device description that is displayed on the user interface 305 of the operating tool 111. Thereto, the operating tool can comprise a display.

FIG. 3 shows how the physically existing measuring system 306 is displayed on the user interface 305 of the operating tool.

In addition, it should be pointed out that “comprising” does not exclude other elements or steps, and “a” or “an” does not exclude a plurality. Furthermore, it should be pointed out that elements or steps which have been described with reference to one of the above embodiments can also be used in combination with other elements or steps of other embodiments described above. Reference characters in the claims are not to be interpreted as limitations.

What is claimed is:

1. An apparatus for generating a user interface configuration for at least one field device, comprising:
a memory arrangement storing a database, the database storing a plurality of device data for the at least one field device; and
a processor generating, as a function of the device data, a user interface description file that is allocated to the at least one field device in at least one predeterminable user interface description language, the at least one predeterminable user interface description language being selected from at least two different user interface description languages.

2. The apparatus according to claim 1, wherein the predeterminable user interface description file is interpreted by a frame.

3. The apparatus according to claim 2, wherein the frame is at least one frame selected from a group consisting of PACTware™, FieldCare, SmartVision, Melody, Freelance, CX Profibus, FDT Container, Fieldmate, Field Device Manager, SIMATIC PDM, Emerson AMS, Emerson Delta V.

4. The apparatus according to claim 1, further comprising:
an input device coupled to the memory arrangement, the input device receiving the device data.

5. The apparatus according to claim 4, wherein the input device has a user rights administration.

6. The apparatus according to claim 1, wherein the processor allows a user rights administration.

7. The apparatus according to claim 1, wherein the user interface description file is selected from a group consisting of a binary file and a text file.

8. The apparatus according to claim 1, wherein the user interface description language is at least one description language selected from a group consisting of DDL, FDT and XML.

9. The apparatus according to claim 1, wherein the device data comprises a first number of device-specific parameters, the user interface description file comprising a second number of device-specific parameters.

10. The apparatus according to claim 9, wherein the first number is larger than the second number.

11. The apparatus according to claim 9, wherein the device-specific parameters are selected from a group consisting of a measuring device name, a sensor name, a field device name, an access right, a version number, a firmware version, a device type, an available function, a device parameter, a parameter dependence, a limiting value, a text in various languages, an input form, a communication rule and a limiting value.

12. The apparatus according to claim 1, wherein the database is at least one database selected from a group consisting of an Oracle database and an SQL database.

13. The apparatus according to claim 1, wherein the memory arrangement stores a web server, the web server controlling the apparatus.

14. The apparatus according to claim 1, wherein the at least one field device is at least one field device selected from a group consisting of a fill-level measuring device, a pressure measuring device and a flow measuring device.

15. The apparatus according to claim 1, further comprising:
a network interface arrangement providing an access to the database via a communications network.

16. The apparatus according to claim 1, wherein the database is an expert system.

17. An apparatus for interpreting a user interface description file, comprising:
an input interface arrangement;
an interpretation device; and
an output interface arrangement,
wherein the input interface arrangement receives the user interface description file in a first user interface description language, the interpretation device converting the user interface description file into a second user interface description language, the interpretation device providing the user interface description file in the second user interface description language at the output interface arrangement.

18. The apparatus according to claim 17, wherein the input interface arrangement receives a user interface configuration file that has been generated by a further apparatus which generates a user interface configuration, the further apparatus includes (a) a memory arrangement storing database, the database storing a plurality of device data for at least one field device; and (b) a processor generating, as a function of the device data, a user interface description file that is allocated to the at least one field device in at least one predeterminable user interface description language, the at least one predeterminable user interface description language being selected from at least two different user interface description languages.

19. The apparatus according to claim 17, wherein the first user interface description language is a text-based description language.

20. The apparatus according to claim 17, wherein the first user interface description language is XML.

21. The apparatus according to claim 17, wherein the second user interface description language is a standard user interface description language.

22. The apparatus according to claim 17, wherein the second user interface description language is one of EDD and FDT.

23. A method for generating a user interface configuration for at least one field device, comprising:
selecting the at least one field device;
predetermining at least one user interface description language; and
generating a user interface description file, allocated to the at least one field device, in the predetermined at least one user interface description language, from a plurality of device data that is stored in a database,
wherein the at least one predeterminable user interface description language is selectable from at least two different user interface description languages.

24. A computer-readable storage medium, in which a program for generating a user interface configuration for at least one field device is stored, which program, when executed on a processor, carries out the following method:
selecting the at least one field device;
predetermining at least one user interface description language; and
generating a user interface description file, allocated to the at least one field device, in the predetermined at least one user interface description language, from a plurality of device data that is stored in a database,
wherein the at least one predeterminable user interface description language is selectable from at least two different user interface description languages.

25. A program element for generating a user interface configuration for at least one field device, which program element, when executed on a processor, carries out the following method:
selecting the at least one field device;
predetermining at least one user interface description language; and
generating a user interface description file, allocated to the at least one field device, in the predetermined at least one user interface description language, from a plurality of device data that is stored in a database,
wherein the at least one predeterminable user interface description language is selectable from at least two different user interface description languages.

26. A method for interpreting a user interface description file, comprising:
receiving a first user interface description file in a first user interface description language at an input interface;
converting the user interface description file into a second user interface description language by an interpretation device; and
providing the user interface description file in the second user interface description language at an output interface.

27. A computer-readable storage medium in which a program for interpreting a user interface description file is stored, which program, when executed on a processor, carries out the following method:
receiving a first user interface description file in a first user interface description language at an input interface;
converting the user interface description file into a second user interface description language by an interpretation device; and
providing the user interface description file in the second user interface description language at an output interface.

28. A program element for interpreting a user interface description file, which program element, when executed on a processor, carries out the following method receiving a first user interface description file in a first user interface description language at an input interface;
converting the user interface description file into a second user interface description language by an interpretation device; and
providing the user interface description file in the second user interface description language at an output interface.
